(19) United States
(12) Patent Application Publication
(10) Pub. No.: US 2004/0251187 A1
(43) Pub. Date: Dec. 16, 2004

(54) Gravity feed brining system and water conditioning systems using the same

(76) Inventor: Larry John Chernoff, Calgary (CA)

Correspondence Address: STEPHEN J. LEWELLYN, 933 OLEANDER WAY SOUTH, SUITE 3, SOUTH PASADENA, FL, 33707, US

(21) Appl. No.: 10/688,562

(22) Filed: Oct. 20, 2003

(51) Int. Cl. C02F 5/00

(52) U.S. Cl. 210/190

(57) ABSTRACT

A gravity feed brining system for a water conditioning system having a brine storage tank and a pressure vessel containing regenerable treatment media is provided. The brining system includes a valved manifold means for directing water flow in the water conditioning system and is operated by a programmable processor. The brine storage tank is elevated above the pressure vessel and the valved manifold means is connected to the brine storage tank and the pressure vessel establishing a flow path therebetween. The positioning of the storage vessel allows a quantity of brine solution to be gravity fed into the pressure vessel during a regeneration cycle, thereby eliminating the need of a venturi, J-tube or pump to transfer the brine solution into the pressure vessel.

### BACKGROUND OF THE INVENTION

1. Field of the Invention

The present invention relates generally to water conditioning systems, such as iron filters, water softeners and the like which use regenerable treatment media. More particularly, relating to a novel gravity feed brining system and water conditioning systems using the same.

2. Description of the Prior Art

Water conditioning systems, such as water softeners, iron filters and the like use treatment media that may be regenerated after being saturated by impurities that have been removed from water during the water treatment process. During regeneration, the treatment media is washed with a brine solution which creates an ionic exchange between the brine solution and the treatment media, thereby removing the impurities from the media. Before the regeneration cycle, brine solution may be formed by dissolving in a quantity of water a regeneration salt in a storage tank which is then transferred from the storage tank to the treatment media during the regeneration cycle. Generally, the entire water conditioning system must remain under pressure during the regeneration cycle to facilitate transferring the brine solution to the treatment media. A typical method of transferring the brine solution includes the use of a venturi to draw the brine solution from the storage tank and transfer it to the treatment media. Using a venturi to transfer the brine solution requires the water conditioning system to use supply water to create a vacuum across the venturi thereby aspirating the brine solution with the supply water, which is then used to regenerate the treatment media.

An example of a typical brining system used with water conditioning systems is disclosed in U.S. Pat. No. 5,045,187 to Suchanek, which includes a water softener regeneration system including a valved manifold in fluid communication with a brine storage tank. Brine solution is transferred from the storage tank by use of a venturi and is directed through the manifold into a pressure vessel which contains the filter media.

Similarly, U.S. Pat. No. 6,193,882 to Grayson discloses a pressurized brining system including a resin tank that has an open drain during a regeneration cycle and a pressurized brine storage tank communicating with the resin tank. The brine storage tank is pressurized with a source of water to facilitate transferring the brine solution to the resin tank.

Lastly, U.S. published patent application 2002/0108909 to Hughes discloses a self-regenerating ion exchange water softener having a lower resin tank in fluidic communication with an upper brine solution tank. A restrictive pressure sensitive valve is place between the resin tank and the brine tank and is operated by sensing pressure changes in the resin tank. The main aspect of this invention is the automatic upward leakage of water into brine tank, coupled with the production of brine therein, followed by automatic gravity downward leakage of the resulting brine after the water pressure has decreased by a user turning off a valve.

While the above-described devices fulfill their respective, particular objectives and requirements, the aforementioned patents do not describe a gravity feed brining system and method of operating, and water conditioning system using the same which reduces water consumption and regeneration cycle time, reduces complexity of the system and reduces manufacturing expense.

### SUMMARY OF THE INVENTION

In accordance with the present invention, a gravity feed brining system for a water conditioning system having a brine storage tank, a pressure vessel and a quantity of regenerable treatment media is provided. The system includes a valved manifold means for directing water flow through the water conditioning system and is connected to the pressure vessel and the brine storage tank. A programmable processor is provided to control actuation of the valved manifold means to control the direction of the water flow in the water conditioning system in either a service mode where water is treated and supplied to a service connection or in a regeneration mode having a regeneration cycle. A sensor, such as a water meter or water quality sensor is connected in fluid communication to the valved manifold means for sensing water usage or water quality. The programmable processor is connected to the sensor and actuates the valved manifold means so as to switch the operation of the water conditioning system from the service mode into the regeneration mode. During the regeneration mode, the programmable processor actuates the valved manifold means so as to direct the water flow in the water conditioning system during the regeneration cycle. In addition, a drain valve is connected to a drain port of the pressure vessel and is operative to drain liquid contents contained within the pressure vessel upon receiving an actuation signal from the programmable processor. Furthermore, the brine storage tank is positioned above the pressure vessel allow a quantity of brine solution to gravity feed from the brine storage tank into the valved manifold means.

In accordance with an additional aspect of the present invention, a water conditioning system using the gravity feed brining system of the present invention is provided. More particularly, the water conditioning system incorporating the gravity feed brining system of the present invention, includes a pressure vessel, a brine storage tank for holding a quantity of brine solution, and a media cell for hold a quantity of treatment. In addition, the water conditioning system can include either in combination or individually a water flow meter or a water quality sensor, a mechanical water filter and a venturi. The brine storage is positioned above the pressure vessel allowing a quantity of brine solution to flow from the brine storage tank into the media cell.

In accordance with an additional aspect of the present invention, a media cell is provided for use in combination with the water conditioning systems of the present invention. More particularly, the media cell includes at least two trays that are orientated horizontally and stacked vertically in a spaced relationship within the media cell. The trays hold a quantity of treatment media selected from any treatment media known in the art for treating or conditioning water. Spacing of the trays provides for air gaps between adjacent trays allowing water and brine solution to flow freely in service and during regeneration. Furthermore, the design of the media cell and the array of spaced trays, water or brine solution is allowed to flow more freely through the treatment media without requiring the water or brine solution to be under high pressure. This is an improvement over prior art pressure vessels wherein the treatment media is typically placed in tall skinny tanks and the pressure vessel is operated under pressure at all times during service and regeneration.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The principal object of the present invention is to provide a gravity feed brining system and method of operating the same for a water conditioning system for reducing water consumption during a regeneration cycle.

Another object of the present invention is to provide a gravity feed brining system and method of operating the same for a water conditioning system which reduces the complexity of the water conditioning system, thereby making the system easier for a consumer to service.

Still a further object of the present invention is to provide a gravity feed brining system and method of operating the same for a water conditioning system which does not interrupt service during a regeneration cycle.

Yet an additional object of the present invention is to provide a gravity feed brining system and method of operating the same for water conditioning system which reduces regeneration cycle time.

Further yet an additional object of the present invention is to provide a gravity feed brining system and method of operating the same for water conditioning system which does not require the entire system to be pressurized during a regeneration cycle.

Lastly, it is an object of the present invention to provide a new and improved gravity feed brining system and method of operating the same that has a low cost of manufacture with regard to both materials and labor, and which accordingly is then susceptible of low prices of sale to the consuming public, thereby making such brining system economically available to the buying public.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a system diagram of a preferred embodiment of the gravity feed brining system and water conditioning system constructed in accordance with the principles of the present invention.

FIG. 2 is control system diagram of a preferred embodiment of the gravity feed brining system constructed in accordance with the principles of the present invention.

FIG. 3 is a detailed view of the distribution block of the gravity feed brining system of the present invention.

FIG. 4 is a system diagram of a preferred embodiment of the gravity feed brining system constructed in accordance with the principles of the present invention; illustrated showing the brine flow path during a regeneration cycle.

FIG. 5 is a system diagram of an alternate embodiment of the gravity feed brining system and water conditioning system constructed in accordance with the principles of the present invention.

FIG. 6 is a system diagram of an alternate embodiment of the gravity feed brining system and water conditioning system constructed in accordance with the principles of the present invention; illustrating the flow path of the brine solution during a regeneration cycle.

FIG. 7 is a system diagram of an alternate embodiment of the gravity feed brining system and water conditioning system constructed in accordance with the principles of the present invention; illustrating the water flow path during a regeneration cycle.

FIG. 8 is diagrammatic view of a treatment media cell constructed in accordance with the principles of the present invention.

The same reference numerals refer to the same parts throughout the various figures.

### DETAILED DESCRIPTION OF THE INVENTION

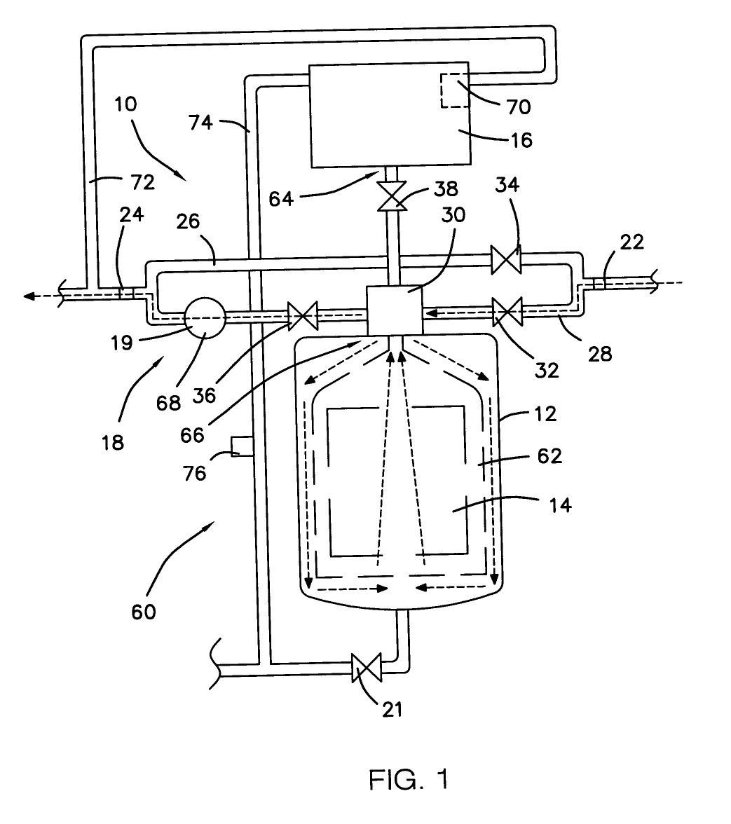

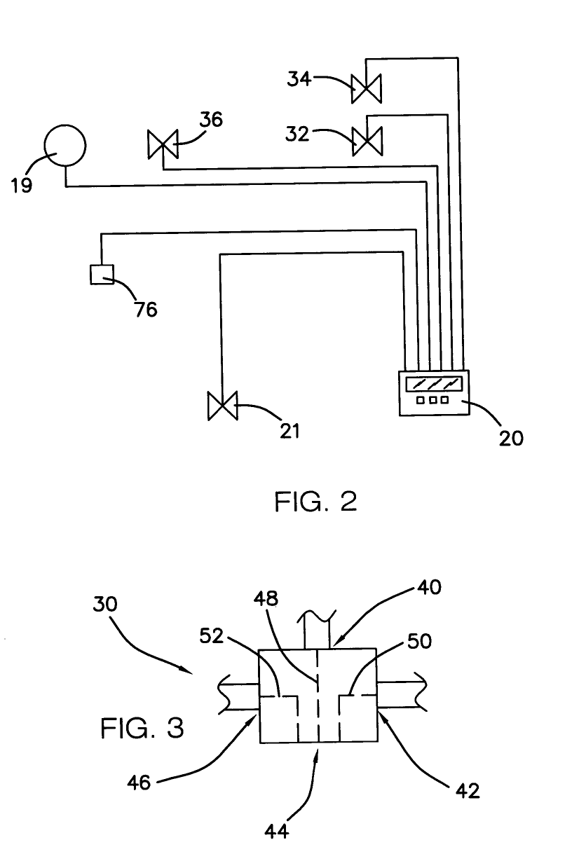

Referring now to the drawings, and particularly to FIGS. 1, 2, and 3, a preferred embodiment of the gravity feed brining system of the present invention is illustrated and generally designated by the reference numeral 10. The gravity feeding brining system 10 of the present invention is designed to be used with a water conditioning system having a brine storage tank 16, a pressure vessel 12 and a quantity of treatment media 14, preferably the treatment media is regenerable.

The gravity feeding brining system includes a valved manifold means 18 for directing the flow of water through the water conditioning system, a programmable processor 20, drain valve 21 and a sensor 19, such as a water usage sensor or a water quality sensor. The programmable processor 20 is connected to the valved manifold means 18 for controlling the operation thereof in accordance with a programmed sequence of events. The programmable processor 20 can be connected to the valved manifold means 18 and the sensor 19 by direct wiring, by radio frequency, by optical connection through fiber optic cable or by infrared light transmission.

The valved manifold means 18 includes a fluid supply connection 22, a fluid service connection 24, a bypass passage 26, a service passage 28, a distribution block 30 which is described in detail later, and a series of valves 32, 34, 36 and 38. The fluid supply connection 22 is for connecting the valved manifold means 18 to a source of untreated water to be treated by the water conditioning system and the fluid service connection 24 is for connecting the valved manifold means to a service line for distributing treated water. The fluid supply connection 22 and the fluid service connection 24 may be any type of conduit coupling device or method that is typically used in the art of plumbing in a water conditioning system. The bypass passage 26 and the service passage 28 are connected to and extend between the fluid service connection 24 and the fluid supply connection 22 establishing two separate flow paths between the fluid service connection and the fluid supply connection. The interior diameters of the bypass passage 26 and the service passage 28 are at least 0.75 inches, preferably from about 0.75 inches to about 1.00 inches.

Turning to FIG. 3, the distribution block 30 is in fluid communication with the service passage 28 and connected thereto intermediate its ends. The distribution block 30 includes a first port 40, a second port 42, a third port 44, and a fourth port 46 and is connected to the service passage 28 intermediate its ends at the second port 42 and the fourth port 46. The distribution block 30 defines a first flow path 48 from the first port 40 to the third port 44, a second flow path 50 from the second port 42 to the third port, and a third flow path 52 from the third port to the fourth port 46. The brine storage tank 16 is connected to the first port 40 and the pressure vessel 12 is connected to the third port 44.

The valves 21, 32, 34, and 36 are operated by a programmable processor 20 for controlling the direction of water flowing in the valved manifold means 18. The first valve 32 is in fluid communication with the service passage 28 and positioned inline therewith between the distribution block 30 and the fluid supply connection 22 and is operative to control fluid flow in the service passage from the second port 42 of the distribution block and the fluid supply connection. The second valve 34 is in fluid communication with the bypass passage 26 and positioned inline therewith between the fluid supply connection 22 and the fluid service connection 24, and is operative to control fluid flow in the bypass passage from the fluid supply connection and the fluid service connection. A third valve 36 is in fluid communication with the service passage and positioned inline therewith between distribution block 30 and the fluid service connection 24, and is operative to control fluid flow in the service passage from the fourth port 46 of the distribution block and the fluid service connection. A drain valve 21 is connected to a drain port of the pressure vessel 12 of the water conditioning system and is operative to drain liquid contents of the pressure vessel upon receiving an actuation signal from the programmable processor 20. The ports and flow path interior diameters are a least 0.75 inches, preferably from about 0.75 inches to about 1.00 inch, thereby providing for unrestricted flow of water therethrough.

A check valve 38, such as a ball check valve is in fluid communication with the first port 40 of the distribution block 30 and a connection port of the brine tank 16 and is positioned therebetween so as to establish a flow path between the brine tank and the distribution block. The check valve 38 is operative in response to pressure within the pressure vessel 12 and controls the flow of brine solution from the brine storage tank 16.

The valved manifold means 18 further includes a series of valves, such as electrically operated solenoid valves that are operated by a programmable processor 20 for controlling the direction of water flowing in the manifold. A first valve 32 is in fluid communication with the service passage 28 and positioned inline therewith between the distribution block 30 and the fluid supply connection 22 and is operative to control fluid flow in the service passage from the second port 42 of the distribution block and the fluid supply connection. A second valve 34 is in fluid communication with the bypass passage 26 and positioned inline therewith between the fluid supply connection 22 and the fluid service connection 24, and is operative to control fluid flow in the bypass passage from the fluid supply connection and the fluid service connection. A third valve 36 is in fluid communication with the service passage and positioned inline therewith between distribution block 30 and the fluid service connection 24, and is operative to control fluid flow in the service passage from the fourth port 46 of the distribution block and the fluid service connection. A drain valve 21 is connected to a drain port of the pressure vessel 12 and is operative to drain liquid contents of the pressure vessel upon receiving an actuation signal from the programmable processor 20. The ports and flow paths interior diameters are a least 0.75 inches, preferably from about 0.75 inches to about 1.00 inch, thereby providing for unrestricted flow of water therethrough.

Now referring back to FIG. 1, the gravity feed brining system 10 of the present invention and a water conditioning system 60 is illustrated and will be described. More particularly, the water conditioning system 60 includes the gravity feed brining system 10, a pressure vessel 12, a brine storage tank 16, a media cell 62 and a quantity of treatment media 14 positioned within the media cell. The brine storage tank 16 includes a connection port 64 and is connected to the distribution block 30 via the connection port 64. The pressure vessel 12 includes a connection port 66 and is connected to the distribution block 30 via the connection port 66.

The media cell 62 is disposed within the pressure vessel 12 and is connected in fluid communication with the distribution block 30 so as to establish a flow path between the brine storage tank 16 and the media cell.

In this embodiment, the sensor 19 is a water flow meter 68 and measures the volume of water treated by the water conditioning system 60. The flow meter 68 is connected to the programmable processor 20 which is programmed to begin a regeneration cycle in accordance with a predetermined water volume value. The predetermined value can be a user programmable value or can be preset for the user during installation of the brining system. The value can be determined by considering many factors, including but not limited to the amount of treatment media used in the water conditioning system, the type of treatment media used, the initial water quality of the water to be treated, the desired water quality after treatment and the storage capacity of the brine storage tank.

A water supply valve 70, such as a float valve or the like, can be connected to a water supply line 72 intermediate the brine storage tank 16 and a source of supply water, such as water treated by the water conditioning system for maintaining a predetermined quantity of water within the storage tank. An overflow drain 74 can be connected to the brine storage tank 16 to drain excess water in the event the water supply valve 70 malfunctions, thereby preventing overfilling of the brine storage tank resulting in possible flooding. Furthermore, a sensor 76 can be installed inline with the overflow drain 74 and connected to the programmable processor 20, which can notify a user of a malfunction upon sensing a flow of water in the overflow drain. The water conditioning system may also remain in the service mode upon the programmable processor sensing water flowing in the overflow drain 74. The brine storage tank 16 can be open to the atmosphere.

In operation, it now can be understood with the water conditioning system operating in the service mode, the first valve 32 and the third valve 36 are maintained open while the second valve 34, the check valve 38 and the drain valve 21 are all maintained in the closed position. The broken lines indicate the water flow path through the conditioning system 60. Water enters the fluid supply connection 22 and is directed into the service passage 28, through the distribution block 30 and into the pressure vessel 12 where it flows downwardly therethrough and then upwardardly into the media cell 62 and through the treatment media 14. Treated water then flows from the media cell 62 through the distribution block 30 into the service passage 28, through the flow meter 68 and then to the fluid service connection 24. When the flow meter 68 measures a volume of water that equals the predetermined water volume value, the programmable processor 20 initiates the regeneration cycle. Ideally, the predetermined water volume value is at least 2,000 gallons, preferably from about 2,000 gallons to about 3,000 gallons.

The programmable processor 20 is programmed with a sequence of time driven events to complete the regeneration cycle. Once the programmable processor 20 initiates the regeneration cycle, the second valve 34 is actuated to open allowing water to flow in the bypass passage 26 to the fluid service connection 24, thereby preventing suspension of service water. The first valve 32 and the third valve 36 are actuated to close, thereby stopping all fluid from flowing into and out of the service passage 28. The drain valve 21 is actuated to open and is held open for at least ten seconds to release pressure and evacuate water from the pressure vessel 12 and is then closed. Preferably, the drain valve 21 is held open from about ten to about fifteen seconds.

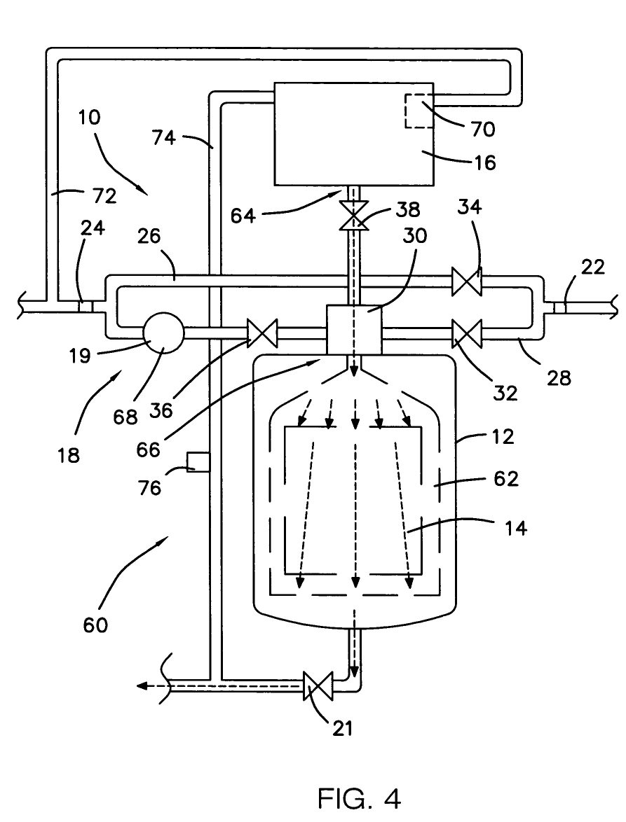

Referring to FIG. 4, which illustrates the flow path of the brine solution during different periods of operation of the regeneration cycle. The check valve 38 opens, due to a pressure drop in the pressure vessel 12, and allows a quantity of brine solution to gravity feed from the brine tank 16 into the media cell 62. The brine solution is held within the media cell 62 a predetermined amount of time allowing an ionic exchange to occur between the brine solution and the treatment media 14. The brine solution can be held within the media cell 62 from about thirty-five to forty minutes and from about forty-five to about fifty-five percent brine solution is used based upon a rejection rate of five gallons per minute. After the ionic exchange period, the drain valve 21 is opened and held open to drain the brine solution from the media cell 62 and out of the pressure vessel 12. After an elapsed time of at least 10 seconds, preferably from about 10 seconds to about 15 seconds, the third valve 36 is opened, thereby allowing untreated water to flow from the bypass passage 26 into the media cell 62 to flush the treatment media 14. During this period, the pressure vessel is repressurized thereby closing the check valve 38.

The treatment media 14 is flushed for at least one minute to one and one half minutes to remove all residues from the media. Ideally, the media is flushed for this time period with untreated water at a flow rate of about 5 gallons per minute. After this time period, the drain valve 21 and the second valve 34 are actuated to close and the first valve 32 is actuated to open, thereby placing the water conditioning system back into the service mode.

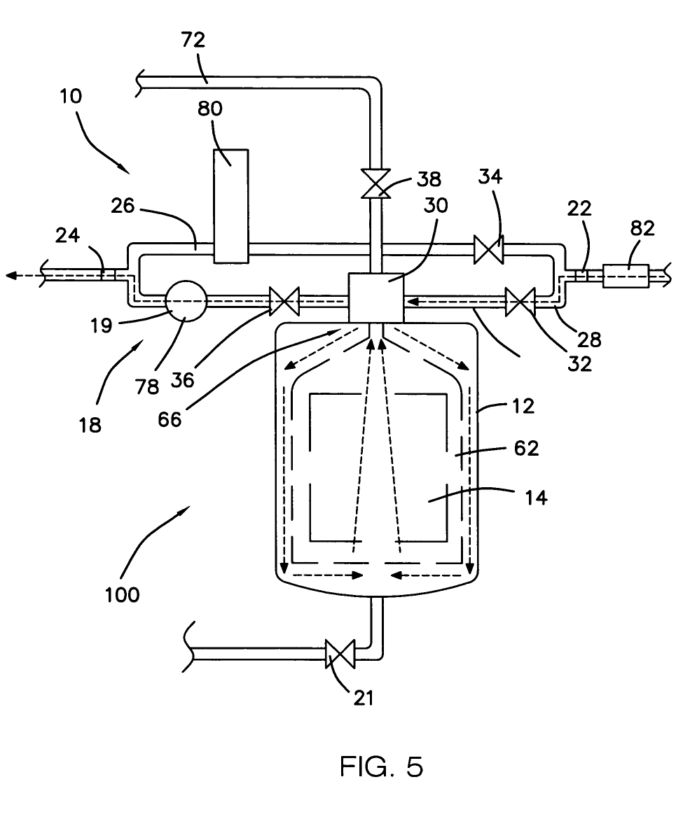

Now referring to FIG. 5, an alternate embodiment of the water conditioning system 100 is illustrated and will be described. More particularly, the water conditioning system 100 includes, a pressure vessel 12, the valved manifold means 18, a media cell 62 and a quantity of treatment media 14 positioned within the media cell. In addition, a water supply line 72 running water treated by the water conditioning system from a pressurized water storage tank (not illustrated) is connected to the check valve 38 for supplying back wash water to the water conditioning system. The pressure vessel 12 includes a connection port 66 and is connected to the distribution block 30 via the connection port 66.

The media cell 62 is disposed within the pressure vessel 12 and is connected in fluid communication with the distribution block 30 so as to establish a flow path between the pressurized water storage tank (already present in the art) and the media cell 62. This design allows the water conditioning system to be installed before the pressurized water storage tank of a non-municipal water supply system. Heretofore, water conditioning systems of the prior art had to be installed after the pressurized water storage tank resulting in untreated water being storage within the pressurized water storage tank. Untreated water carrying impurities greatly reduces the usable life the pressurized water storage tank and associated components. The water conditioning system 100 of the present invention increases the usable life of the pressurized water storage tank and associated components.

In this alternate embodiment, the sensor 19 is a water quality sensor 78 and measures the levels of impurities present in water treated by the water conditioning system 100. The water quality sensor 78 is connected to the programmable processor 20 which is programmed to begin a regeneration cycle in accordance with a predetermined level of an impurity, such but not limited to iron present in the treated water. The predetermined value can be a user programmable value or can be preset for the user during installation of the brining system. The value can be determined by considering many factors, including but not limited to the amount of treatment media used in the water conditioning system, the type of treatment media used, the initial water quality of the water to be treated, the desired water quality after treatment and the storage capacity of the brine storage tank.

In addition, the alternate water conditioning system 100 can include a mechanical water filter 80, such as a canister filter having a replaceable filter cartridge. The mechanical water filter 80 can be connected in fluid communication with the bypass passage 26 of the valved manifold means 18 for treating water flowing through the bypass passage to the service connection 24.

An air injector 82 can be added to the water conditioning system 100 for aspirating untreated water to precipitate solids, such as iron from the untreated water before being passed through the pressure vessel 12.

Referring to FIGS. 5, 6 and 7, it now can be understood with the water conditioning system 100 operating in the service mode, the first valve 32 and the third valve 36 are maintained open while the second valve 34, the check valve 38 and the pressure tank 12 drain valve 21 are all maintained in the closed position. The water flow path through the water conditioning system 100 is indicated by broken line. Water enters the fluid supply connection 22 flows through the service passage 28 into the distribution block 30, down the pressure vessel 12 and upward through the media cell 62 where it is treated by the treatment media 14. Treated water then flows from the media cell 62 through the distribution block 30 into the service passage 28, and then through the water quality sensor 78 to the fluid service connection 24. The water quality sensor 78 measures impurity levels present in the treated water and if a measured level equals or is above the predetermined level, the programmable processor 20 initiates a regeneration cycle. In addition, if the water conditioning system is an iron water filter, the air injector 82, already present in the prior art, can be placed in front of the valved manifold means 18 before the fluid supply connection 22 so that water to be treated is passed through the air injector 82 to precipitate iron from the water before entering the water conditioning system 100.

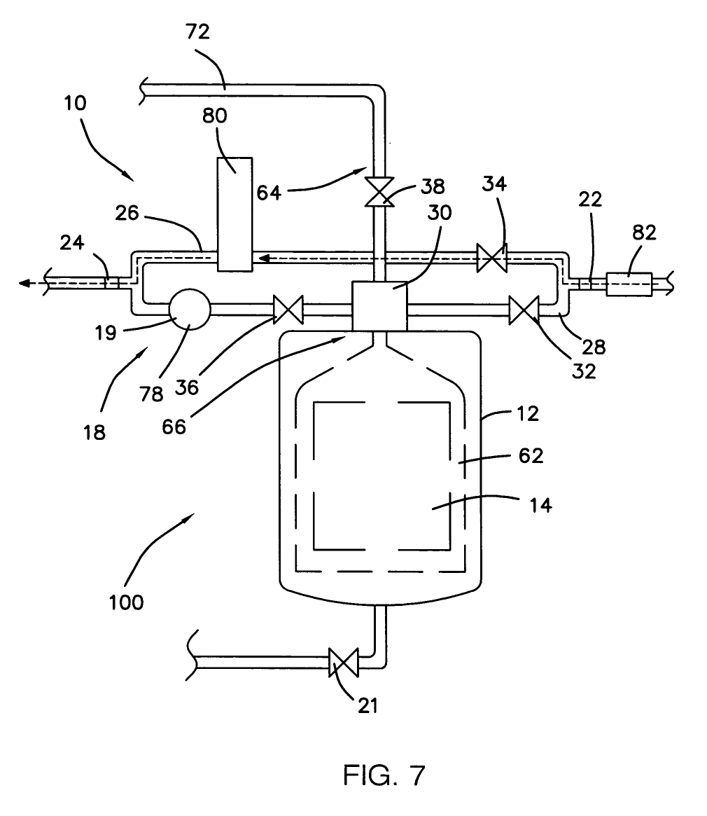

Now referring to FIG. 7, the programmable processor 20 is programmed with a sequence of time driven events to complete the regeneration cycle. Once the programmable processor 20 initiates the regeneration cycle, the second valve 34 is actuated open allowing water to flow in the bypass passage 26 and through the particulate filter 80 if used to the fluid service connection 24, thereby preventing suspension of service water. The first valve 32 is actuated to close, thereby stopping all fluid from flowing into and out of the service passage 28 from the fluid supply connection 22. The third valve 36 remains open allowing water from the bypass passage 26 to enter the pressure vessel 12. Then the drain valve 21 is actuated to open and is held open for at least one minute to wash the treatment media 14. After the rinse, the third valve 36 is closed while the drain valve 21 remains open for at least an additional 10 seconds and then is closed; this dumps the pre-rinse water out of the pressure vessel 12.

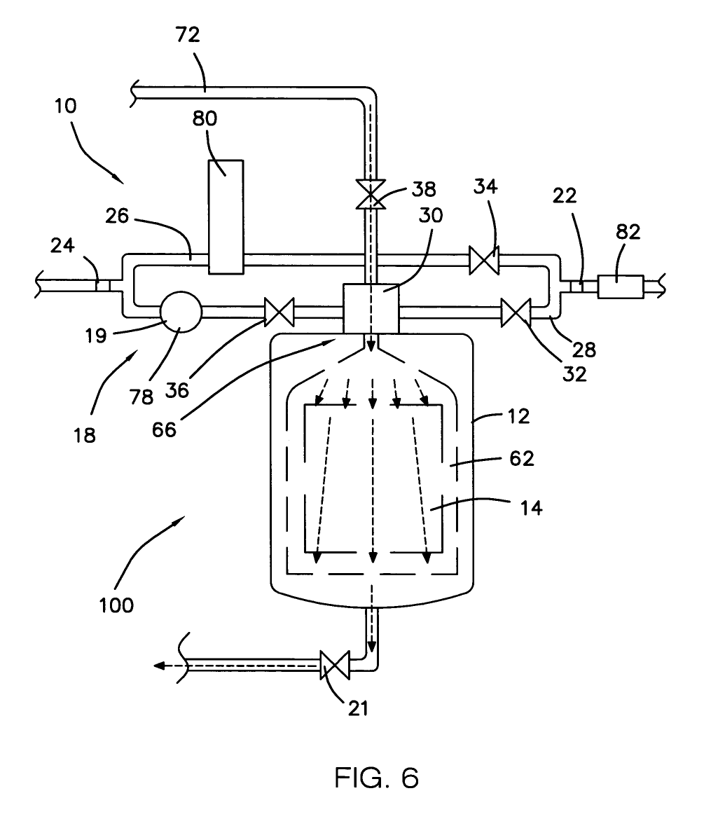

Referring to FIG. 6, as the pressure decreases in the pressure vessel 12, the check valve 38, such as a ball check valve opens allowing treated water from line 72 to gravity feed into the media cell 62. The treated water is held within the media cell 62 for about twenty-five to fifty minutes to soak particles of impurities, removed from the water during treatment, from the treatment media 14.

After the ionic exchange period, the third valve 36 is opened to pressurize the system and to close the check valve 38. The drain valve 21 is opened from about 1 to about 1.5 minutes flushing the treatment media 14 and is then closed. Next the second valve 34 is closed and the first valve 32 is opened repressurizing the pressure vessel 12 and restoring the water conditioning system back to the service mode.

The regeneration cycle for the water conditioning system 60 takes about thirty to about sixty-five minutes to complete and for the water conditioning system 100 about twenty minutes to complete with no interruption of service water and no contamination of brine solution with untreated water. In addition, because the brine solution is gravity feed, no venturi or J-tube is needed to transfer the brine solution, and the brine tank 16 remains free of sediment. Due to the efficiency of the brining system 10, only about 4 to about 8 pounds of regeneration salt is used. Furthermore, about twenty-five to about forty-gallons of water is used during during the complete regeneration cycle for the water conditioning system 60 and about twenty-five to about fifty gallons of water is used during the complete regeneration cycle of the water conditioning system 100, thereby minimizing wastewater in view of current water condition systems.

In an alternate embodiment of the water conditioning system 60, the brine storage tank 16 is replaced with a potassium permanganate pot and green sand is used as the treatment media 14. The green sand, used in place of other media, traps iron and removes it from the water being treated. A potassium permanganate solution is used in instead of a brine solution for flushing the treatment media 14. The potassium permanganate solution is saturated with oxygen atoms, which attracts and removes iron particles from the green sand during flushing thereof. This alternate embodiment would operate in accordance with the water conditioning system 60 as previously described.

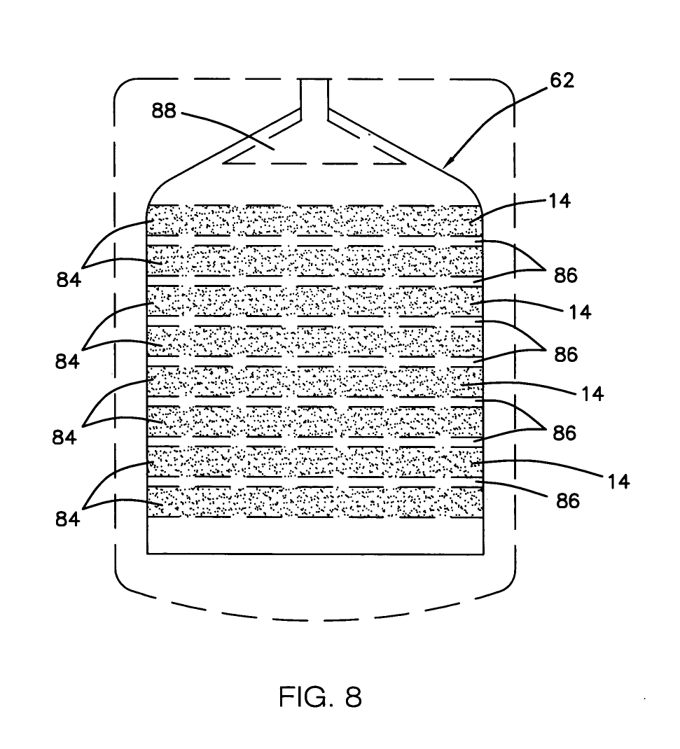

Now referring to FIG. 8, the media cell 62 of the present invention is illustrated and will be described. More particularly, the media cell 62 comprises at least two trays 84 that are orientated horizontally and stacked vertically in a spaced relationship. The trays 84 have perforated bottoms and hold a quantity of the treatment media 14, and each tray can hold a quantity of different treatment media. Spacing of the trays 84 provides for air gaps 86 between adjacent trays allowing water and brine solution to flow freely in service and during regeneration. Due to the design of the media cell 62, the media cell and the pressure vessel 12 do not need to be pressurized during a regeneration cycle. The media cell 62 can include a distributor head 88 for showering brine solution across the trays 84 stacked within the media cell. The trays 84 are adapted to contain treatment media 14 of a chosen type and to evenly subject the treatment media to water or brine solution flowing through the trays. The chosen treatment media may be selected from any available media used for conditioning or treating water. Furthermore, the design of the media cell 62 and the array of spaced trays, water or brine solution is allowed to flow more freely through the treatment media with out requiring the water or brine solution to be under high pressure. This is an improvement over prior art pressure vessels wherein the treatment media is typically placed in tall skinny tanks and the pressure vessel is operated under pressure at all times during service and regeneration. The design of the present invention, allows the treatment media to be regenerated without the pressure vessel being pressurized.

While a preferred embodiment of the brining system has been described in detail, it should be apparent that modifications and variations thereto are possible, all of which fall within the true spirit and scope of the invention. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A gravity feed brining system for a water conditioning system having a brine storage tank for holding a quantity of brine solution, a pressure vessel and quantity of regenerable treatment media, comprising:
a valved manifold means for directing water flow through the water conditioning system, said valved manifold means connected in fluid communication to the brine storage tank and the pressure vessel;
a programmable processor electrically connected to said valved manifold means;
a sensor connected to said valved manifold means in fluid communication therewith;
a drain valve connected to the pressure vessel in fluid communication therewith and said drain valve is electrically connected to said programmable processor; and
the brine storage tank is positioned above the pressure vessel.

2. The gravity feed brining system of claim 1, wherein said programmable processor is programmed to control actuation of said valved manifold means.

3. The gravity feed brining system of claim 1, wherein said sensor is a flow meter and is electrically connected to said programmable processor for measuring water usage.

4. A gravity feed brining system and a water conditioning system, comprising:
a brine storage tank for holding a quantity of brine solution, said brine storage tank having a connection port;
a pressure vessel having a drain port;
a media cell for holding a quantity of treatment media, said media cell disposed within said pressure vessel;
a valved manifold means for directing the flow of water through the water conditioning system, said valve manifold means connected to and in fluid communication with said pressure vessel, said brine storage tank and said media cell;
a programmable processor electrically connected to said valved manifold means;
a drain valve connected to the drain port of said pressure vessel;
a sensor connected to said valved manifold means in fluid communication therewith; and
said brine storage tank is positioned above said pressure vessel.

5. The gravity feed brining system and water conditioning system of claim 4, wherein said sensor is a flow meter connected in fluid communication to said valved manifold means and electrically connected to said programmable processor.

6. The gravity feed brining system and water conditioning system of claim 4, wherein said valved manifold means comprising:
a fluid supply connection;
a fluid service connection;
a bypass passage in fluid communication with the fluid supply connection and the fluid service connection and extending therebetween;
a service passage in fluid communication with the fluid supply connection and the fluid service connection and extending therebetween;
a distribution block having a first port, a second port, a third port and a fourth port, said distribution block in fluid communication with the service passage and connected thereto intermediate its ends at the forth and second ports;
a first valve in fluid communication with said service passage and positioned in-line thereto between said distribution block and said fluid supply connection;
a second valve in fluid communication with said bypass passage and positioned in-line thereto between said fluid supply connection and said fluid service connection;
a third valve in fluid communication with said service passage and positioned in-line thereto between said fluid service connection and said distribution block;
said first valve, said second valve and said third valve electrically connected to said programmable processor; and
a check valve in fluid communication with the first port of said distribution block and the connection port of said brine storage tank.

7. The gravity feed brining system and water conditioning system of claim 4, further comprising:
a supply valve connected intermediate to a source of supply water and said brine storage tank.

8. The gravity feed brining system and water conditioning system of claim 7, wherein the source of supply water is water that has been treated by the water conditioning system.

9. The gravity feed brining system and water conditioning system of claim 8, wherein said brine storage tank is closed to the atmosphere.

10. The gravity feed brining system and water conditioning system of claim 4, further comprising:
at least two media trays each for holding a quantity of treatment media, said at least two media trays are orientated horizontally and stacked vertically in a spaced relationship within said media cell.

11. The gravity feed brining system and water conditioning system of claim 10, wherein said at least two media trays contain a quantity of different treatment media.

12. The gravity feed brining system and water condition system of claim 4, wherein said sensor is a water quality sensor connected in fluid communication to said valved manifold means and electrically connected to said programmable processor.

13. The gravity feed brining system and water condition system of claim 4, further comprising a mechanical water filter connected in fluid communication to said valved manifold means.

14. The gravity feed brining system and water conditioning system of claim 4, further comprising an air injector connected in fluid communication with said valved manifold means.

15. The gravity feed brining system and water conditioning system of claim 4, wherein said first valve, said second valve, said third valve and said drain valve are electrically operated solenoid valves.

16. The gravity feed brining system and water conditioning system of claim 4, wherein said brine storage tank is open to the atmosphere.

17. The gravity feed brining system and water conditioning system of claim 16, further comprising:
an overflow drain connected to said brine storage tank.

18. The gravity feed brining system and water conditioning system of claim 17, further comprising:
a water flow sensor connected in fluid communication with said overflow drain, said water flow sensor connected to said programmable processor.

19. A gravity feed brining system and water conditioning system comprising:
a brine storage tank for holding a quantity of brine solution, said brine storage tank having a connection port;
a pressure vessel having a drain port;
a media cell for holding a quantity of treatment media, said media cell disposed within said pressure vessel;
at least two media trays each for hold a quantity of treatment media, said at least two media trays are orientated horizontally and stacked vertically in a spaced relationship within said media cell;
a supply valve connected intermediate to a source of supply water and said brine storage tank;
a valved manifold means for directing the flow of water through the water conditioning system, said valve manifold means connected to and in fluid communication with said pressure vessel, said brine storage tank and said media cell;
a programmable processor electrically connected to said valved manifold means;
a drain valve connected to the drain port of said pressure vessel; and
said brine storage tank is positioned above said pressure vessel.
